(19) United States
(12) Patent Application Publication
(10) Pub. No.: US 2026/0249464 A1
(43) Pub. Date: Aug. 27, 2026

(54) METHOD FOR THE OPTIMUM CONTROL OF A DEVICE BY WAY OF MILP, COMPUTER PROGRAM FOR PERFORMING THE METHOD, AND CORRESPONDING APPARATUS

(71) Applicant: Siemens Aktiengesellschaft, München (DE)

(72) Inventors: Christoph Moll, München (DE); Sebastian Pol, Fürth (DE); Markus Michael Geipel, München (DE); Ingo Thon, Grasbrunn (DE)

(21) Appl. No.: 19/160,333

(22) PCT Filed: Feb. 26, 2024
(86) PCT No.: PCT/EP2024/054760

§ 371 Date: Aug. 27, 2025

(30) Foreign Application Priority Data
Feb. 28, 2023 (EP) 23159057.1

(51) Int. Cl. B25J 9/16; B65G 61/00

(52) U.S. Cl. CPC B25J 9/1671; B25J 9/1664; B65G 61/00; G05B 2219/31449; G05B 2219/39001

(57) ABSTRACT

The disclosure relates to the optimization of a movement control of a device, wherein the device is suitable and configured for picking up objects and putting them back down. The present solution proposes to use mixed-integer linear programming methods to assign objects to target positions and to assign shipments to order pickers.

The present patent document is a § 371 nationalization of PCT Application Serial No. PCT/EP2024/054760, filed Feb. 26, 2024, designating the United States, and this patent document also claims the benefit of European Patent Application No. 23159057, filed Feb. 28, 2023, which are incorporated by reference in their entireties.

### TECHNICAL FIELD

The disclosure relates to an optimization of a movement control of a device, wherein the device is suitable and configured for picking up objects and putting them back down.

### BACKGROUND

There are a variety of tasks in automation facilities that include picking up and moving objects.

Manufacturing facilities, among them, (e.g., packaging facilities), in greatly varying branches of industrial automation use conveyor belts, for example, on which objects, products, or parts of products may be located in an unsorted or irregular manner. Examples are found in the primary and secondary packaging branches, for example, in the food and beverage industry. The number and the arrangement of the products per unit of conveyor area may vary strongly in this case.

A handling machine, also referred to as a device hereinafter, may be understood as a so-called delta kinematics robot or a robot that is used in automation.

For a packaging procedure, multiple handling devices, such as industrial robots, also called delta pickers or articulated arm robots, may be used in series in order to carry out a “pick-and-place,” thus picking up the product from the conveyor belt and repositioning it.

The described procedure is not restricted to these examples, however. Further applications include, in addition to the pick-and-place operations, packaging, (e.g., palletizing products), and many more.

When operating a series of essentially identical devices, which may all carry out the same tasks, (e.g., constructed in series on a conveyor belt), one challenge is to decide which machine fulfills the task. If a series of pick-and-place devices are to fill a box with products from a conveyor belt, it then has to be decided, among other things, which object is picked (i.e., picked up, moved, and placed at the correct location) by which device. In certain arrangements of this type, any product may be picked up and processed (picked) by any of the devices, which results in a high degree of flexibility for the processing of the tasks. Rules are to be observed in the selection of device and object to be picked up. For example, a device cannot pick up two objects lying adjacent to one another or cannot put down objects on positions located closely adjacent to one another. More pickers have to divide the picking among one another.

In addition, separate picking lines are configured in each case for different tasks, which require different optimization criteria. For example, the main task in some applications is to pick up all objects from the conveyor belt in a timely manner (for example, filtering plastic objects out of a waste stream). In other applications, in contrast, it is more important that a packaging unit is completely filled (for example, a chocolate box), while it is less problematic if a few objects were not picked at the end of the conveyor belt and fall down. A further demanding scenario may be to place yogurt cups in pallets so that the flavors are mixed uniformly within a pallet.

In addition to this compromise between the optimization goals, there may be the problem that current assignment strategies do not take into consideration the wear of the devices. If the workload is not uniform, the pickers accordingly wear out at different speeds, which results in frequent and irregular maintenance intervals, higher failure times, and ultimately in higher operating costs.

While current assignment strategies may fulfill the above-described core task in certain scenarios, they do not take into consideration, for example, the above-mentioned challenge of the uniform wear of the devices. This is, in particular, because modern strategies do not provide any coordination between the various devices. Instead, each device is equipped with an individual guideline that decides which objects are picked in its work zone.

Known strategies are, among other things, to pick the object located closest to the (picking or gripping) arm of the device, is located farthest forward on the conveyor belt.

However, these individual strategies result in the next problem, where the first devices of a line have a much higher workload than those devices that are located at the end of the processing section.

Document EP3456485A1 describes the optimization of an automated procedure for selecting and gripping an object by way of a robot. The basic concept is to assign a priority identifier to each object, which is taken into consideration by the robot when selecting and gripping the object.

An online scheduler is known for a robot, which is to grip products from a transport medium and place them in packages, from “Modeling and design of an optimal line manager of a packaging system with MILP,” G. Ferrari et al., Proceedings of the 41 st annual conference of the IEEE Industrial Electronics Society, IECON 2015. The goal is to lose as few products as possible, i.e., which fall from the transport medium at the end. The travel path of the robot is optimized by a MILP algorithm, where the direction and speed of the transport medium also play a role here.

“Fast MILP-based Task and Motion Planning for Pick-and-Place with Hard/Soft Constraints of Collision-Free Route,” by Takuma Kogo et al., Proceedings of the 2021 IEEE International Conference on Systems, man, and Cybernetics (SMC), identifies that the goal is to calculate a collision-free trajectory curve and to reduce the demand for computing power by MILP.

### SUMMARY AND DESCRIPTION

It is the object of the disclosure to specify a method, improved in relation to the prior art, to map many different applications, and to carry them out independently of one another online or offline. It is furthermore an object of the present disclosure to specify a computer program and a corresponding apparatus.

The scope of the present disclosure is defined solely by the appended claims and is not affected to any degree by the statements within this summary. The present embodiments may obviate one or more of the drawbacks or limitations in the related art.

The proposed method is used to optimize a movement control of a device, wherein the device is capable of and configured to pick up objects and put them down again.

For each object, information about a starting position and information about possible destination positions is known in each case, and the starting and/or destination positions change their position predictably over the course of time.

Further boundary conditions are taken into consideration, such as described in further below.

The calculation of a travel curve for the device takes place, wherein the travel curve includes multiple operations, the approach to a starting position of a first object, and then the approach to a destination position of the first object, and a starting position and then a destination position of a further object until reaching an end position or another stop condition, wherein the travel curve has to meet at least one optimization criterion. The determination of a destination position for each object from the set of the possible destination positions and the calculation of the travel curve resulting therefrom on the basis of the starting and destination positions takes place using the method of mixed integer linear programming (MILP).

The end position is reached here when the device has reached the end of the range. However, further stop conditions are conceivable.

One reasonable end position for an empty device (picker) is, for example, the center point of the belt beginning on which the objects come, i.e., the point where new objects are expected. In the case of a loaded picker (i.e., having a picked-up object that is intended to be deposited), it is the center of the beginning of the belt having the destination positions, thus the point where new destinations are expected.

In the present solution, the use of methods of mixed integer linear programming (MILP) for assigning objects to destination positions and transports to pickers is proposed.

Optimization in the mathematical sense means the determination of the maximum or minimum of a real-value function over a (e.g., restricted) range or state space and the argument space for which the function adopts this extreme value. A special case thereof is mixed integer linear programming (MILP). This is increasingly also used in the sectors of logistics, transport, production planning, finances, communication, and design, also because the combinatorial optimization and the traveling salesman problem, machine occupancy problems, sequencing problems, transport, and assignment problems may be formulated with its aid and in particular by the use of binary-variable problems.

There are high-performance computer programs, called solvers, which have been able to solve such mathematical problems for MILP rapidly and in most cases optimally.

One significant advantage of this technology is that different inventory configurations may be modeled therewith.

A further advantage is that the models may be formulated so that only solutions that meet all technical requirements are calculated. Greatly differing criteria may be formulated for the selection among the permitted solutions. This offers a high level of flexibility in the modeling of certain tasks.

The mathematical modeling of the problem advantageously takes place beforehand offline in this case. In this way, sufficient time is available to detect and define the existing tasks, and this time is then not lacking during the productive phase.

Viewed formally, initially the existing starting situation includes recognized objects, which are located on a transport device or apparatus, such as a conveyor belt, and predictably change their position in the course of the transport. The positions of the newly added objects may be unordered here and are initially not predictable.

The existing starting situation also includes destination positions, which are located, for example, on a further conveyor belt, thus also change their position, likewise predictably, over the course of time. These may be individual destination positions or also groups of destination positions.

The existing starting solution also includes a group of devices that are to pick up the objects (pick operation) and place them on the destination positions (place operation). These devices are individually controlled in the prior art and operate independently of one another.

Proceeding from the above-mentioned information, the following is therefore sought: (1) an assignment of the objects to destination positions, and (2) a sequence of transport, pick-and-place, and idle operations of the devices (also called picking) of objects to destination positions.

Different boundary conditions occur in practice, which may furthermore be taken into consideration in the calculation of a movement control (this list is exemplary and is not exhaustive): (1) the type of the movement of the devices also has an effect on the wear of the devices, which also applies in particular for the acceleration of the devices in the various axes; (2) the picking-up and/or placing procedures (picking procedures) may each be carried out from movable transport belts or temporary stop belts; (3) the arrangement of the transport apparatuses may be arranged in parallel (running in the same direction or opposite directions) or orthogonal to one another; (4) the devices may pick up only one or multiple objects simultaneously; (5) the destination positions may accommodate one or more objects (for example, shafts for stacks in a cookie package); and (6) the destination positions may be located in groups.

Different requirements may also exist with respect to the logistical boundary conditions: (1) restrictions of which object is placed in which destination position, for example, depending on the shape of the object and the destination position; and (2) conditions for classes of objects and classes of destination positions, for example, a green object in each field or an object having strawberry flavor.

The overall model may be decomposed into multiple components by the described procedure. This advantageously enables many different applications to be mapped by a manageable set of parameterizable model formulations. Furthermore, the components may be executed independently of one another online or offline.

In the present example, our model is decomposed: (a) into a first structure, in which various logistical requirements are mapped (combinatorial model); (b) a second structure, which maps the various inventory configurations and the physical properties of the transport apparatuses, and (c) a class of “coupling conditions.”

For element a) of the model, the first (combinatorial) structure describes: permissible sequences of pick-and-place operations (there cannot be two picking-up procedures in succession); boundary conditions with respect to the picking of the objects (i.e., whether all objects have to be lifted); and boundary conditions with respect to the destination positions (i.e., whether one or more objects have to be placed at each destination position).

In the model, for example, 0-1 variables (value either 0 or 1) are used to map combinatorial conditions. Other notations are conceivable.

If the device/the devices (pickers) each alternately execute a picking-up action and a placing action, it is sufficient to introduce a variable for each possible loaded journey (with an object to a destination) and for each possible empty journey (from the starting position of a picker or a destination position to an object).

In this case, permissible assignments correspond to the occupancies of the (0-1) variables with the following conditions: precisely one empty journey starts at each starting position of a picker; precisely one empty journey ends at each object; precisely one loaded journey begins at each object; precisely one loaded journey ends at each destination position; and at most one empty journey ends at each destination position.

If a 0-1 occupancy is present for the variables, sequences of journeys are then calculated for the device in that they begin with a starting position, from there with (precisely) one loaded journey to a placement position, then to (precisely) one pick-up position or at the end to a destination position. The device therefore obtains a path.

An occupancy of the variables that satisfies these equations defines paths that begin at the starting positions, alternate between objects and destination positions, and end at an end position.

It may also be permissible in the conditions that all pickers travel directly from starting to end positions and in each case an empty journey and a loaded journey from an object to a destination and an empty journey from the destination back to the object is selected. This would also be referred to as a “circuit.” In many mathematical models, these “circuits” have to be explicitly forbidden. This is not required in the proposed method because the coupling condition factually couples the time of picking-up and placing, and this makes circuits impossible as long as all travel times are >0.

If sequences are also to be observed in which not all objects have to be picked and/or not all destinations have to be supplied, further (0-1) variables are introduced and the equations are expanded in that, for example, the following is formulated: precisely one empty journey starts at each starting position of a device/picker; precisely one empty journey ends at each object or it is not picked up; precisely one loaded journey begins at each object or it is not picked up; precisely one loaded journey ends at each destination position or it is not served; and at most one empty journey ends at each destination position or it is not served.

The assignment of the devices to the individual objects and destination positions results implicitly from the sequence of the acts. If an assignment variable is additionally explicitly modeled, continuous [0,1] variables (thus variables that may adopt an arbitrary value between 0 and 1) may be used.

These assignment variables describe which picker approaches which object/destination. The use of a 0-1 variable may prevent two pickers from each half approaching one destination.

In one embodiment, in this case [0,1] variables may also be used, since these variables are integers as the sum of [0,1] variables. The computing times are therefore shortened.

The following conditions are then used: the starting positions are each assigned to one device/picker; each object and each destination position is served by one device/picker; if a loaded journey is selected, the same device/the same picker is assigned to the destination as the object; and if an empty journey is selected, the same device/the same picker is assigned to the object as the destination position at which the empty journey starts.

Many restrictions with respect to possible assignments may be modeled, in that the set of the possible journeys is restricted. Other conditions such as counting objects of individual classes (e.g., “green object,” “polygonal object,” “object having weight=500 g”) in individual target groups (“box”) are advantageously enabled by an expansion of the instance description and the model by concepts such as object classes and target groups.

For element b) of the model, the physical model uses continuous variables to describe the time and the location of each operation. One example would be a point in time and a point in a local coordinate system of the picker here. In fact, a picking procedure is a process that occupies a certain amount of time while the position of the object changes. The transition between the individual phases (empty journey, picking up the object, loaded journey, and placement procedure on the destination space) is therefore fuzzy. In our model, a fixed point in time is used as the reference point for each operation. An arbitrary point in time of a procedure clearly defined on the machine may advantageously be selected here.

There is only one degree of freedom for the operation to be performed by the device, since the objects and destination positions on the transport apparatuses move on a (straight) line past the picker at a known speed and the point in time of the procedure uniquely determines the geometric coordinates.

One possible implementation is to define a 0 line orthogonal to the belt direction for each picker and to declare the distance of the position to this line as the “offset” variable. This offset and the position of the object or the destination position on the belt then imply the point in time of the operation.

The restrictions of the action range of the picker may be expressed as the upper and lower limits for these variables. For this purpose, the segment, on which the position moves and which is located in the usage range of the picker, of the straight line is determined.

If the two conveyor belts having the objects and the destinations run parallel or in opposite directions, a common 0 line may be defined for both conveyor belts and extended to form an orthogonal coordinate system of the picker. All objects and destination positions then move in this coordinate system parallel to an axis, so that one coordinate is constant for each object and each destination position. The other coordinate corresponds to the offset. This may be used to express travel times between two points as inequality conditions between the offset variables.

In certain examples, the following furthermore applies: in loaded journeys, the object position and destination position and the times of the work acts are to be selected so that the difference between the point in time of the space use and the point in time of the picking procedure is greater than the duration which the picker requires to perform the loaded journey.

The conditions for empty journeys apply accordingly.

In order to couple the two models, the following implication is modeled: if a loaded journey from an object to a destination position is selected, the above condition then has to be met.

All conditions mentioned here may be written down directly in MILP form (Mixed Integer Linear Programming).

For the last equation, we have used a Big M method.

A Big M formulation is a standard method to formulate logical conditions in MILPs.

In order, for a 0-1 variable x and a continuous variable y, to express the following logical condition: (x=0)≥(y=0).

A sufficiently large M may be selected and the following inequality may be used: y≤x*M, 0≤y, (wherein, if x=1, then y≤M is not a restriction as long as M is sufficiently large).

This is used to formulate conditions that only apply if a special journey was selected.

If a loaded journey is selected, the point in time of picking up the object and the point in time of placing the object at the destination have to be at least as far apart from one another as the journey lasts.

If an empty journey is selected, the point in time of the prior placement and the point in time of picking up have to be at least as far apart from one another as the journey lasts.

The model arises offline, the calculation takes place in the online case for scenarios defined by the camera, and decisions have to be taken into consideration here that were already transmitted to the picker.

To actuate specific devices using this model, the model has to be cyclically solved and transferred to the controller, which then calculates the driving commands for the devices.

### BRIEF DESCRIPTION OF THE DRAWINGS

Advantageous exemplary embodiments are shown in the figures. In the figures:

FIG. 1 depicts an example of a schematic overview having objects and destination positions.

FIG. 2 depicts the situation of FIG. 1 with calculated transport paths.

FIG. 3 depicts an example of movement of the device in the vertical direction over time using the physical model.

FIG. 4 depicts an example of an architecture overview.

### DETAILED DESCRIPTION

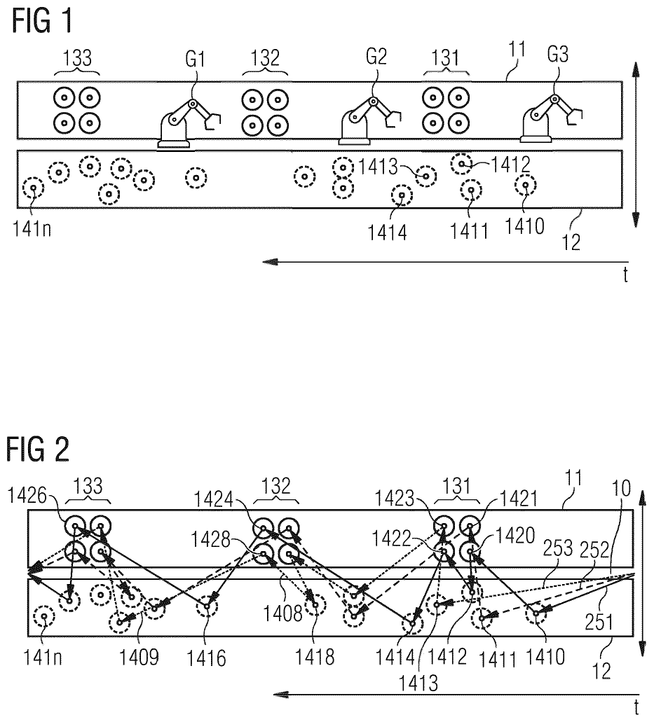

FIGS. 1, 2, and 3 each show a top view of an arrangement of two conveyor belts arranged in parallel, which have the same running direction. This arrangement was only selected to illustrate the method. Another arrangement of the conveyor belts, for example, orthogonal as described above, is possible but is not shown in the figures.

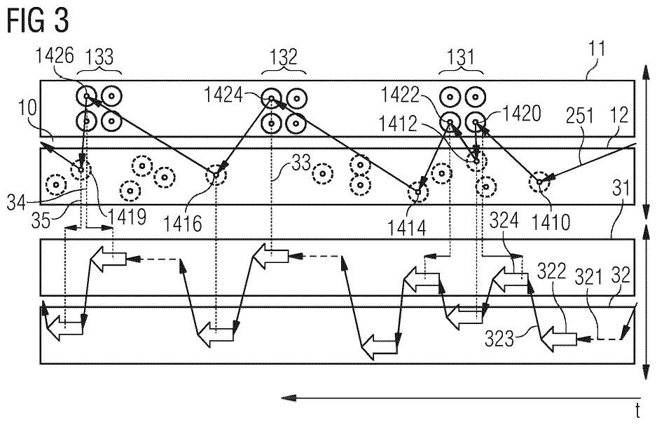

The devices G1, G2, and G3 are arranged along the conveyor belt. FIGS. 2 and 3 describe the movements of the devices relative to the conveyor belt.

Identical reference signs each identify identical objects or positions.

The objects 1410, 1411, . . . 141n to be picked up are each located on the lower conveyor belt 12 and the destination positions 1420, 1421, . . . , 142n, to which the objects are to be transported and placed there, are located on the upper conveyor belt 11. In the illustrated example, these are furthermore groups of destination positions, thus, for example, a package, a box, a pallet, a blister, or the like, 131, 132, 133, for accommodating multiple objects, which possibly specifies further framework conditions for the determination of the control.

The information shown in FIG. 1 represents the starting information for the method: which starting positions the individual objects have, for example with coordinate information (x, y), and which destination position (x′, y′). The devices G1, G2, G3 are suitably arranged on the transport belt, and the running direction of the transport apparatuses is represented by the arrow t.

FIG. 2 now shows the result of a calculation using the proposed method on the basis of the data from FIG. 1. In each case, it is the assignment of the respective devices G1, G2, G3 (not shown) to the objects and the travel lanes of the three devices, 251, 252, and 253. The object 1410 is assigned in the illustrated example to the destination position 1420. In this case, initially an empty journey from the starting position to the object 1410 is planned and performed, subsequently thereto picking up the object 1410, then a loaded journey (with the object 1410) to the determined destination position 1420. In the example shown, all destination spaces are occupied with objects at the end, which may be seen in that one of the three travel curves 251, 252, and 253 is shown at each destination position. However, not all objects (141n) are possibly picked up and picked by the first transport apparatus.

In FIG. 3, in the upper half of the illustration, the two conveyor belts 11, 12 having the objects 1410, 1412, . . . and the destination positions 1420, 1422, . . . are shown, analogously to FIGS. 1 and 2. For better visibility, only the sequence of the running path 251 and the operations of one of the devices is shown this time.

The lower half of the graphic shows the (same) movement of the device over the conveyor belts 31, 32 in somewhat greater detail. In particular the deviation 34, 35 of the position from the 0 position 1426 in the vertical direction (in relation to the conveyor belt) over time is shown and represents the individual actions of the device: after starting from the destination position, initially “waiting” 321 for the first object, then a pick action 322, which occupies a certain time. In this case, the pick-up apparatus has to be moved at the same speed as the transport apparatus. Next, the path of the transport procedure 323, at maximum speed, to the second conveyor belt 31 is shown. As the next procedure, the placement of the object 324 takes place, and a time for the placement procedure is also calculated in here. The offset of the arrow 324 to the position 1420 corresponds to the offset variable. The pick-up takes place “early” so that the operation 1422 may still be performed by the same device. The operations 1424 and 1416 are performed exactly at the moment in which the object/destination runs through the 0 line of the device. The offsets are utilized again at the end of the journey.

After completion of the last placement procedure, the device/the pick-up apparatus is moved back to the starting position again.

The large arrows 322 indicate movements that take place in synchronization with the respective transport apparatus in order to enable an object to be picked up or placed.

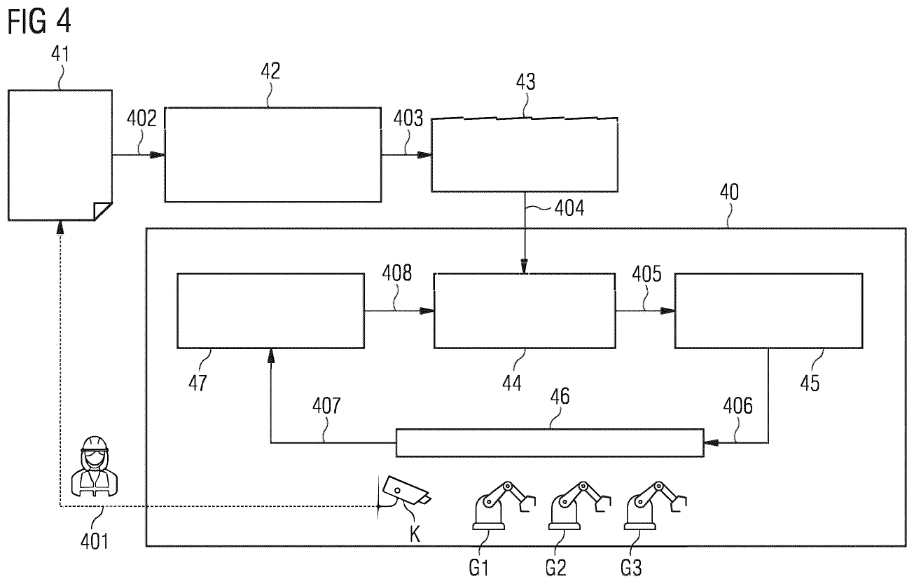

FIG. 4 shows an architecture overview, as already described above. A part of the method acts take place offline, before running the productive method, and another part then online, 40, thus during the productive operation of the facility in question. In the preparation, a problem definition, 41, is necessary; this was already explained by way of example above on the basis of the present example. An instance-specific model is created and parameterized, 42, from the rules and equations 402 thus created. The data and models thus determined are transferred, 403, for calculation to a MILP model (Mixed Integer Linear Programming) 43.

The operation loop now following takes place “online” in productive operation and uses a problem-specific optimizer, 44. The optimizer is used to calculate an optimum plan for a distribution of articles and destination positions on the belts.

The obtained data 404 (and/or 408 from a control loop) are transferred to the MIP solver, the result also runs through a postprocessing act 45, and in this case the recognized objects are assigned to the available devices G1, G2, G3 to be picked up. This begins with a situation in which a plan (for a journey) is calculated and is transferred, 406, to the controller 46.

The trigger for a complete recalculation is an update of the information about objects and destination positions on the belt, for example, by the evaluation of camera images, k, which monitor an area of the belts 11, 12 or the devices G1, G2, G3.

When the current instance is compared with the last instance, some objects have disappeared (picked up, transported, processed) and some new objects have been added (in the observed camera field). The remaining objects and positions were already assigned to devices or pickers during the last planning run. In addition, in the last iteration, the planned points in time were calculated at which the procedures are to take place.

In the next act, it is defined which part of the planning is “frozen,” 47. This applies for all procedures that take place in the period of time necessary to recalculate the plan and convert it into travel instructions.

This “frozen” part of the solution is mapped as fixed variables in the mathematical model. With these additional conditions 408, the model described in the last section may then be used unchanged for the incremental planning.

A significant advantage of this technology is that different inventory configurations may be modeled, also individually and also beforehand (offline). A further advantage is that the models may be formulated so that only solutions that meet all desired technical requirements are calculated. Very different criteria may be formulated here for the selection among the permitted solutions. This offers a high level of flexibility in the modeling of certain tasks.

The optimizer corresponds to a mathematical model and an array of parameters that define the specific inventory (e.g., number of the pickers, usage area, feeder alignment, highest speeds, maximum acceleration, duration of the operations) and the logistical rules. The construction of this model is a technical act and may include model expansions.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

### LIST OF REFERENCE SIGNS

G1, G2, G3 device
T running direction
10 positioning of devices
11 transport device with destination positions
12 transport device with starting positions, objects
131, 132, 133 groups of destination positions
1410, . . . 141n object, starting position
1420, . . . 142n object, destination position
251, 252, 253 travel curve
321 empty journey
322 picking up object at starting position
323 loaded journey
324 placing object at destination position
40 online operation cycle
41 problem definition
42 generation of instance-specific model and parameterization
43 MILP model
44 solver (discrete optimizer)
45 postprocessing
46 control
47 preprocessing, definition of frozen data
406 assignment of devices to objects
407 list of objects
402, 403, 404 intermediate results
405, 408 intermediate results

1. A computer-implemented method for optimizing a movement control of a device from a plurality of devices, wherein the device is capable of and configured to pick up objects, the computer-implemented method comprising:
creating and parameterizing an instance-specific model;
defining an optimization problem, wherein information on a starting position and information about possible destination positions (2420, 2421, . . . ) are known for each object, wherein the starting position and/or the destination position change predictably over time, and wherein further boundary conditions are taken into consideration;
calculating a travel curve for the device, wherein the travel curve meets at least one optimization criterion, and wherein the travel curve comprises: a pick-up action with approach to the starting position of the object; a placement action with approach to the destination position of the object; and optionally an approach to a starting position of a further object and an approach to a destination position of the further object until reaching an end position or stop condition:
creating and parameterizing an instance-specific model, wherein a computer-implemented optimizer based on a mixed integer linear programming model obtained from the instance-specific model is used in a determination of the destination position for each object from a set of possible destination positions and the calculation of the travel curve resulting therefrom based on the starting and destination positions; and
assigning the recognized objects to the available devices to be picked up and outputting control signals for the travel curve of the device,
wherein the method is applied to simultaneous optimization of respective travel curves of at least two devices working in parallel from the group of devices, and
wherein the optimization of a respective travel curve takes place based on wear of the device resulting from movement changes contained in the determined travel curve and the distance covered.

2. The method of claim 1, wherein the optimization of the respective travel curve further takes place based on a minimum time, a maximum pick-up quota of objects, or a combination thereof.

3. (canceled)

4. The of claim 1, wherein the modeling of the output parameters of the optimization method, takes place offline.

5. The method of claim 1, wherein the calculation of the travel curve takes place online, and
wherein control signals previously transmitted to the device are taken into consideration.

6. The method of claim 1, wherein the boundary conditions are logistical boundary conditions or boundary conditions of the devices.

7. The method of claim 1, wherein an instance description is modeled with aid of at least one assignment variable for the starting position and the destination position and each object.

8. The method of claim 7, wherein the instance description is expanded by an object class for more accurate definition of the object.

9. The method of claim 7, wherein the instance description is expanded by destination groups for grouping destination positions.

10. The method of claim 1, wherein the travel curve takes into consideration a duration that would be occupied by performance of the control signals by the device,
wherein continuous [0,1] variables are used to describe the time and the location of each operation, and
wherein a fixed point in time is used as a reference point for each operation.

11. The method of claim 10, wherein the considered operations further include picking up the object and placing the object.

12. The method of claim 1, wherein, for each device, a setpoint position on the travel curve is defined and the distance of the position from the setpoint position is established as an offset variable.

13. The method of claim 1, wherein the Big M method is used to formulate conditions.

14. The method of claim 1, wherein updating information about the starting position of objects and destination positions on the belt requires a recalculation, and
wherein a part of the planning data is frozen for this purpose, including for all procedures that take place in the period of time required to perform the recalculation and convert the recalculation into travel instructions.

15. (canceled)

16. An apparatus configured to optimize a movement control of a device from a plurality of devices, wherein the device is capable of and configured to pick up objects, the apparatus comprising:
a controller configured to:
define an optimization problem, wherein information on a starting position and information about possible destination positions are known for each object, wherein the starting and destination positions change their position predictably over time, wherein further boundary conditions are taken into consideration;
calculate a travel curve for the device, wherein the travel curve meets at least one optimization criterion, and wherein the travel curve includes multiple operations comprising: approaching starting position and destination position, picking up the object, and placing the object, until reaching an end position or stop condition, wherein a computer-implemented optimizer based on a mixed integer linear programming model obtained from a instance-specific model is used for determining a destination position for each object from the possible destination positions and calculating the travel curve resulting therefrom based on the starting and destination positions; and
assign the recognized objects to the available devices to be picked up and outputting control signals for the travel curve of the device,
wherein the controller is configured to conduct a simultaneous optimization of respective travel curves of at least two devices working in parallel from the group of devices, and
wherein the optimization of a respective travel curve takes place based on wear of the device resulting from movement changes contained in the determined travel curve and the distance covered.

17. The apparatus of claim 16, wherein the optimization of the travel curve is configured to further take place based on a minimum time, a maximum pick-up quota of objects, or a combination thereof.

18. (canceled)

19. The apparatus of claim 16, wherein the controller is further configured to:
receive a previously performed modeling of starting parameters of the optimization method, and
wherein the calculation of the travel curve takes place in running operation.

20.-28. (canceled)

29. The apparatus of claim 19, wherein the starting parameters of the optimization method comprise the starting and destination positions and the at least one optimization criterion.

30. The method of claim 4, wherein the output parameters of the optimization method comprise the starting and destination positions and the at least one optimization criterion.

31. The method of claim 7, wherein the at least one assignment variable is a continuous [0,1] variable or a 0-1 variable.
